(19) United States
(12) Patent Application Publication
(10) Pub. No.: US 2025/0018660 A1
(43) Pub. Date: Jan. 16, 2025

(54) COMPOSITE PREPREG CONSTRUCTIONS AND METHODS FOR MAKING THE SAME

(71) Applicant: University of Southern California, Los Angeles, CA (US)

(72) Inventors: Mark Anders, Los Angeles, CA (US); Steven Nutt, Irvine, CA (US)

(21) Appl. No.: 18/702,327

(22) PCT Filed: Sep. 29, 2022
(86) PCT No.: PCT/US2022/045277

§ 371 Date: Apr. 17, 2024

Related U.S. Application Data
(60) Provisional application No. 63/283,967, filed on Nov. 29, 2021.

(51) Int. Cl. B29C 70/00; B29B 11/16; B29C 70/20; B29C 70/44; B29K 105/08

(52) U.S. Cl. CPC B29C 70/003; B29B 11/16; B29C 70/20; B29C 70/44; B29K 2105/0881; B29K 2995/0065

(57) ABSTRACT

Through-thickness permeable prepregs comprise a fiber bed and a plurality of discrete resin regions on a surface of the fiber bed separated by exposed fiber bed surface regions. Prepreg assemblies for processing such prepregs comprise an air permeable resin barrier material disposed over a surface of the prepreg opposite a forming tool. The air permeable resin barrier material is permeable to air or gas passing from the prepreg and is impermeable to resin passing from the prepreg. During processing, the prepreg assembly is subjected to a vacuum and elevated temperature to cure the resin and form a composite part. During processing, the air permeable resin barrier material prevents unwanted resin bleed from the prepreg, causing resin pressure in the prepreg to be maintained that reduces or eliminates unwanted formation or growth of internal voids to provide a composite part having a reduced degree of internal voids and pores.

### CROSS REFERENCE TO RELATED APPLICATIONS

This application claims the benefit and priority of U.S. Provisional Patent Application No. 63/283,967 filed Nov. 29, 2021, entitled “COMPOSITE PREPREG CONSTRUCTIONS AND METHODS FOR MAKING THE SAME,” the entire disclosure of which is hereby incorporated by reference in its entirety.

### GOVERNMENT LICENSE RIGHTS

This invention was made with United States government support under Contract No. NSF PFI-TT-1827788 by the National Science Foundation. The United States government has certain rights in this invention.

### FIELD

Composite prepreg constructions as disclosed herein are manufactured in a manner that provides an improved degree of air removal during consolidation and cure while retaining all resin in the prepreg plies to thereby produce a composite structure having greatly reduced or eliminated internal porosity and aesthetically unacceptable surface defects.

### BACKGROUND

Currently, composite parts as made for use in such applications as aerostructures and the like are produced from prepregs (i.e., a partially cured, fiber-reinforced precursor material already impregnated with a synthetic resin) that are consolidated/cured in autoclaves. These processes limit production rates and part sizes, and attach significant cost burdens, both capital and operating, to the production of such parts. The use of an autoclave for making composite parts or structures from prepregs thus presents a production bottleneck. For example, to reach future production rates required for the manufacture of single-aisle aircraft, alternatives to autoclave cure of prepregs that are faster and less costly must be identified, or such aircraft will not be designed with composite materials.

Out of autoclave (OoA) prepregs (prepregs cured outside of an autoclave) and methods for making the same are known, and have been developed to address these problems and provide a route around the bottleneck. Such known OoA prepregs feature channels for evacuating or air or gas during processing and cure that are located in the plane of the fiber bed. Basically, fiber beds (woven fabric or unidirectional (UD) fibers) are partly impregnated with resin film, leaving dry fiber channels at the mid-plane to facilitate air removal during cure. These “breathing pathways” are effective for in-plane air removal, i.e., through the ends of the prepreg, but offer little or no ability to evacuate air or gas in the out-of-plane or through-thickness direction due to the presence of the resin covering the top and/or bottom surfaces of the fiber bed. As a result, limitations arise when making (a) large parts with long breathe-out distances, and (b) parts with corners, ply drop-offs, or other geometric features which occlude the in-plane “breathing pathways” and trap air in the part. Further, the use of such conventional OoA prepregs also requires meticulous attention to detail during part production. Additionally, it is often desired to repair a damaged composite prepreg part or structure. Such known OoA prepreg formats that rely on in-plane air or gas removal do not allow for a high quality repair because the repair geometries typically occlude the in-plane air or gas breath out paths of the prepreg during processing and cure.

One approach to address the lack of through-thickness “breathing pathways” in such traditional prepreg formats is embodied in “Z-preg”, a prepreg format featuring wide resin strips applied to dry woven fabric, which affords additional through-thickness air or gas permeability. A drawback to Z-pregs and conventional OoA prepreg formats, and the prepreg products, structures, and parts formed therefrom, is resin-flow issues during processing, including excessive resin bleed, lack of complete resin saturation of the fabric leading to resin-starved regions, and premature occlusion of breathing pathways. Because of both the large spacing between resin strips and the large width of the resin strips in Z-preg, the drawbacks cited above are problematic, and thus Z-preg is not widely used to form composite products, structures or part.

Another approach to address the lack of through-thickness “breathing pathways” in such traditional prepreg formats, and to improve on the through-thickness “breathing pathways” provided by the Z-preg is embodied in a prepreg comprising resin provided in the form of a plurality of discrete resin regions on the surface of the fiber bed rather than being provided in the form of the wide resin strips as with the Z-preg. While the prepreg construction comprising the plurality of discrete resin regions provides improved features of resin flow such as a better degree of impregnation and saturation of the fiber bed and a reduced degree of through-thickness breathing pathway occlusion during processing when compared to the Z-preg, there still exists resin issues that occur during process that impacts the ability to produce products, structures, or parts having a desired reduced degree of internal porosity and minimal surface defects.

There is, therefore, a need/desire to develop a more robust prepreg format and approach for prepreg processing that functions to both overcome both the bottleneck issue associated with using autoclaves, and addresses the above-noted limitations associated with the known OoA approach of processing prepregs into composite structures.

### SUMMARY

Prepreg assemblies and composites as disclosed herein comprise a through-thickness air or gas permeable prepreg comprising a fiber bed and a plurality of discrete resin regions disposed on a surface of the fiber bed. In an example, the fiber bed is unidirectional. In an example, the discrete resin regions are configured having a uniform pattern on the fiber bed surface. In an example, the discrete resin regions are formed separately from the fiber bed and are disposed thereon in a preformed state. In an example, the discrete resin regions are formed by depositing a film of resin on a carrier and de-wetting the film of resin to form the discrete resin regions, and wherein the discrete resin regions are disposed on the fiber bed surface by pressing a surface of the carrier comprising the discrete resin regions into contact with the fiber bed surface and removing the carrier therefrom.

In an example, the discrete resin regions are separated by exposed surface regions of the fiber bed that are not covered by the discrete resin regions, wherein the exposed surface regions facilitate the through-thickness permeation of air or gas therethrough during processing. Prepregs as disclosed herein may comprise two or more piles in laminate form comprising fiber beds and discrete resin regions disposed on one or both sides of each of the fiber beds

Prepreg assemblies used for processing such through-thickness permeable prepregs disclosed above comprise such prepreg as combined with an air permeable resin barrier material that disposed over the surface of the prepreg that is opposite a forming tool. The air permeable resin barrier material is permeable to air or gas passing from the prepreg and is impermeable to resin passing from the prepreg. In an example, the prepreg discrete resin regions and exposed fiber bed surface region are configured to facilitate air or gas removal from the prepreg in a through-thickness direction of the prepreg during a prepreg curing process. The air permeable resin barrier material is configured to permit such air or gas removal from the prepreg while also preventing resin passage from the prepreg during such prepreg curing process. In an example, the prepreg assembly may further comprise a bag disposed over at least a portion of the prepreg assembly for subjecting the prepreg assembly to a vacuum condition.

Methods for processing such through-thickness permeable prepregs disclosed above comprise combining such prepregs with the air permeable resin barrier material to form an assembly as disclosed, and subjecting the prepreg assembly to vacuum and elevated temperature conditions that cures the resin to form a composite structure, product, or part therefrom. In an example, the prepreg may be formed by depositing the discrete resin regions onto the surface of the fiber bed. In an example, the discrete resin regions are formed by depositing a resin film onto a surface of a carrier that is separate from the fiber bed and treating the resin film to cause the resin film to disperse into the discrete resin regions. In an example, the discrete resin regions on the surface of the carrier are deposited onto the surface of the fiber bed by pressing the surface of the carrier comprising the discrete resin regions into contact with the fiber bed surface so that the discrete resin regions adhere to surface of the fiber bed and are transferred from the surface of the carrier. In an example, the method may further comprise placing a bag over the prepreg and the air permeable resin barrier material for subjecting the prepreg to a vacuum condition during the curing process.

During the process of subjecting, air or gas permeates in a through-thickness direction from the prepreg and passes from the surface of the prepreg through the air permeable resin barrier material thereby promoting efficient air or gas removal from the prepreg to prevent trapped air or gas from forming voids or pores in the composite structure, product, or part. During the process of subjecting, resin passage from the surface of the prepreg is restricted or prevented by the air permeable resin barrier material thereby reducing or mitigating resin pressure loss during processing and the associated unwanted formation of bubbles and resulting internal void or pore formation. In an example, during the step of subjecting, the prepreg discrete regions of resin flow and saturate the fiber bed and the resin maintains at least about 50 percent, and from about 60 to 100 percent of its pressure through the step of curing. In an example, the resulting composite structure, product, formed in accordance with such method comprises less than about two percent by volume internal porosity.

Through-thickness permeable prepregs and assemblies comprising the same as combined with the air permeable resin barrier material as disclosed above (in place of a conventionally used perforated release film discovered to be resin permeable) for prepreg processing under vacuum and elevated temperature conditions are specifically constructed to maintain resin pressure during such processing conditions as a result of restricting or preventing unwanted resin bleed that effectively reduces or eliminates the formation of unwanted internal voids caused by trapped resin volatiles or bubbles to thereby produce composite structures, products, or parts having reduced internal voids and pores.

### BRIEF DESCRIPTION OF THE DRAWINGS

Other apparatus, systems, methods, features, and advantages of prepregs and approaches and methods for processing the same as disclosed herein will be appreciated as the same becomes better understood by reference to the following detailed description and attached materials when considered in connection with the accompanying drawings wherein:

FIG. 1 is a schematic view of a conventional method for making OoA prepreg constructions;

FIG. 2 is a cross-sectional schematic view of a conventional OoA prepreg construction having a continuous resin film applied on both sides;

FIG. 3 is a cross-sectional schematic view of a conventional OoA prepreg construction having a continuous resin film applied on only one side;

FIG. 4 is a photomicrograph of the surface of a conventional OoA prepreg;

FIG. 5 is a schematic view of a method of making a prepreg as disclosed herein;

FIG. 6 is a schematic view of a method of making a prepreg as disclosed herein;

FIG. 7 is a schematic perspective view of a method of making a prepreg as disclosed herein;

FIG. 8 is a schematic perspective view of a method of making a prepreg as disclosed herein;

FIG. 9 is a schematic view of process steps of making a prepreg as disclosed herein;

FIG. 10 is a photomicrograph of a resin film during de-wetting according to principles as disclose herein;

FIG. 11 is a photomicrograph of a prepreg as disclosed herein comprising a fiber bed comprising discrete resin regions disposed on a surface of the fiber bed formed by a de-wetting process as disclosed herein;

FIG. 12 is a cross-sectional schematic view of a prepreg as disclosed herein;

FIG. 13 is a photomicrograph of a surface of a prepreg as disclosed herein;

FIG. 14 is a schematic view of a prepreg processing assembly, used for processing and curing a prepreg as disclosed herein, using a conventional perforated release film;

FIG. 15 is a photomicrograph of a surface of a composite sheet formed using the prepreg processing assembly of FIG. 14;

FIG. 16 is a schematic view of a prepreg processing assembly, used for processing and curing a prepreg as disclosed herein, using an air permeable resin barrier material as disclosed herein;

FIG. 17 are photomicrographs showing surfaces of composite sheets formed using the prepreg assembly of FIG. 16; and

FIG. 18 is a graph showing resin pressures of the prepreg processing assemblies of FIGS. 14 and 16 during processing and cure under vacuum and heated conditions.

### DESCRIPTION

Disclosed herein are apparatuses, systems, and methods to produce composite prepreg constructions with high permeability in the through-thickness direction and having near-zero internal porosity. A feature of the process of making prepregs as used herein is the process used to provide discrete resin regions on a fiber bed and leaving regions of the fiber bed surface not covered with discrete resin regions exposed (gaps), e.g., unidirectional fiber, or woven fabric or non-crimp fabric or a textile, thus greatly facilitating through-thickness air removal from the prepreg during consolidation and cure during processing, e.g., under vacuum and elevated temperature conditions, to form composite products, structures, or parts and thereby reducing/eliminating strength-limiting porosity. A further feature as disclosed herein is the method and assembly used for processing the prepregs as disclosed herein that makes use of an air permeable resin barrier material (in place of a conventional perforated release film) as combined with the prepreg to reduce/eliminate resin bleed or resin migration from the prepreg during processing to retain resin pressure throughout processing and thereby avoid an unwanted creation of voids or porosity within the cured composite product due to resin pressure loss. As used herein, and as understood in the art, the term “fabric” is interchangeable with “woven fabric” or “non-woven fabric.” The gaps or discrete resin regions may have various geometric configurations, including parallel strips or grids or may be randomly configured. Other configurations such as various patterns (regular and irregular), among others, may be provided. The gaps may surround discrete islands of resin. The gaps may comprise perforations in a film.

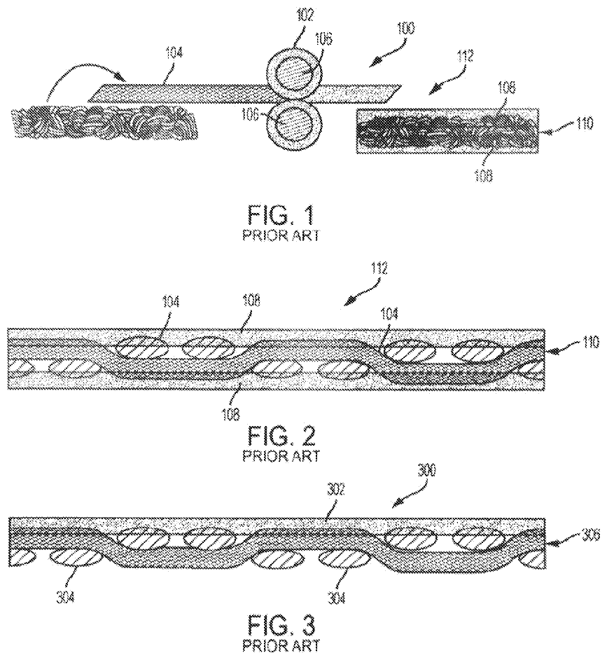

FIG. 1 illustrates for reference a conventional method 100 for making an OoA prepreg as disclosed in the background above comprising breathing pathways in the plane of the fabric component. As illustrated, resin material 102 is combined with a desired fabric bed 104 (shown in close-up and at a smaller scale in FIG. 1) e.g., by way of rollers 106, causing the fabric bed 104 to be partly impregnated with the resin to form a continuous resin film 108 in the impregnated region. This leaves dry fabric channels 110 at the mid-plane of the resulting prepreg 112 (a single ply shown in FIG. 2) to facilitate air removal during OoA curing processes. Such a process commonly features continuous films applied to both sides of a fabric bed (as shown in FIG. 1), and which are partly impregnated, leaving in-plane evacuation channels to facilitate air removal during consolidation.

FIG. 2, for example, shows a schematic cross sectional view of the resulting prepreg 112 in which both surfaces (top and bottom) of the fabric bed 104 have been impregnated with a continuous resin film 108. The fabric bed 104 comprises a weave having fiber tows in the weft and warp directions. The dry fabric channels 110 are available for air to escape during curing processes. FIG. 3, as an additional example of a conventional method, shows a resulting prepreg 300 (a single ply shown in FIG. 3) in which only one surface (the top surface) the fabric bed 304 has been impregnated with a continuous resin film 302. The prepreg 300, however, during a curing process may be stacked with other similar prepreg plies, such that the only air channels that remain are in-plane dry fabric channels 306.

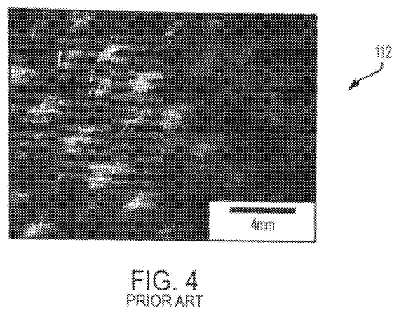

FIG. 4 illustrates a photomicrograph of the top surface of the conventional OoA prepreg 112, in which the entirety of the top surface is shown to be impregnated with the continuous resin film.

The distribution of polymer resin according to methods and principals disclosed herein for making prepregs useful for making prepreg assemblies for forming composite products, structures, or parts as disclosed herein contrasts with such conventional methods of making prepregs intended for Out-of-Autoclave curing (OoA). Such prepregs useful for making prepreg assemblies for forming composite products, structure, or parts as disclosed herein generally comprise a number of discrete resin regions disposed on a surface of a fiber bed. The discrete resin regions comprise discontinuous resin on the surface of the fiber bed. The discrete resin regions serve to enhance the through-thickness air or gas permeability of the prepregs to thereby enhance removal of air or gas from the prepreg during a debulking and curing processes. Various patterns (regular or irregular) of the discontinuous resin may be applied to the surface of the fiber bed. In methods disclosed herein, the discrete resin regions may comprise resin islands, or a number of discrete pore regions within the resin (or a resin grid). In certain embodiments, perforated resin films may be applied to the surface of the fiber bed.

In methods disclosed herein, a distance between the resin regions may be measured to provide desired exposed portions of the fiber bed surface to facilitate permeation of air or gas through the exposed portions of the fiber bed surface in a direction perpendicular to a plane of the fiber bed during a curing process of the prepreg. The measuring may include controlling, prescribing, designing, creating, or performing other forms of measuring. The distance may be determined to produce a desired result, as discussed regarding methods herein.

The methods disclosed herein may also contrast with conventional methods of making prepregs because the methods disclosed herein may not rely on the particular surface topography or architecture of the fiber bed to form the discrete resin regions. Prior forms of deposition may form resin regions by relying on raised or heightened portions of a fabric weave to cause the resin regions to be formed (e.g., relying on a raised contact surface of the fiber bed, which may contact a roller or the like). The methods disclosed herein may be utilized with multiple forms of fiber beds (fabric or unidirectional fiber bed or a non-crimp fabric or a textile) having multiple forms of surface topography or architecture. The methods disclosed herein may be utilized with a fiber bed having no significant surface perturbations, such that the surface of the fiber bed may be considered to be flat. This is a feature recognized with unidirectional fiber beds. The methods disclosed herein accordingly differ from prior methods, which may rely on the surface topography or architecture of the fiber bed to produce discrete resin regions, and may not be usable with unidirectional fiber beds.

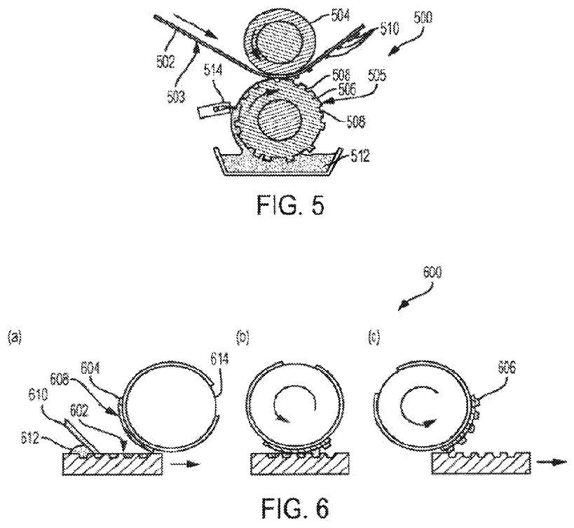

One method for forming such prepregs is by a process of applying a configuration of a number of discrete resin regions to a surface of a fiber bed by applying a printing surface to the surface of the fiber bed. The printing surface may have recesses corresponding to the configuration and that include the resin. Application of the printing surface comprising the recesses containing the resin to the surface of the fiber bed effectively applies the discrete resin regions to the fiber bed surface. FIG. 5 illustrates a process 500 in which a fiber bed 502 has a surface 503 upon which a printing surface 505 is applied. The printing surface 505 includes a number of recesses 508 that are configured to correspond to the configuration of the discrete resin regions 510 on the surface 503 of the fiber bed 502. The shape and position of the recesses 508 on the printing surface 505 defines the shape and position of the discrete resin regions 510 on the surface 503 of the fiber bed 502. For example, a desired depth of the recess in the printing surface 505 may dispense a desired thickness of resin material onto the fiber bed 502.

The surface 503 of the fiber bed 502 may be passed along the printing surface 505 to apply the discrete resin regions 510 thereon. As shown in FIG. 5, the printing surface 505 may comprise a roller 506 that rolls relative to the surface 503 of the fiber bed 502. An opposing roller, or impression roller 504, may also be utilized. The fiber bed 502 may pass between the rollers 504, 506. The printing surface 505 may rotate through a reservoir or liquid bath 512 to apply the resin material to the printing surface 505. A measuring blade, a doctor blade, or the like 514 may be utilized to remove excess resin from the printing surface 505 of the roller 506 before it is placed into contact with the fiber bed 502.

The recesses 508 of the printing surface 505 may comprise grooves as shown in FIG. 5. The grooves may be parallel grooves to apply a pattern of parallel strips to the surface 503 of the fiber bed 502. In an example, resin strips of selected width (e.g., from about 1-10 mm) and spacing (e.g., from about 1-10 mm) may be applied in this manner. As shown in FIG. 5, irregular size and spacing of the strips may be provided. In other embodiments, other configurations of resin may be applied to the surface 503, including grids and other patterns (whether regular or irregular). The configuration of the recesses may be determined based on the desired configuration of resin to be applied to the surface 503 (e.g., a grid pattern of recesses may be provided on the printing surface 505 to provide a desired grid pattern on the surface 503). While the recesses 508 in the form of grooves illustrated in FIG. 5 are oriented running parallel to an axis of the roller 506, it is to be understood that the grooves may be formed at any angle to the roller axis to apply the strips at any angle to the fiber bed 502. In an embodiment in which the fiber bed 502 is a fabric, the strips may be applied at an angle to the warp and weft tows of the fabric as desired for the end-use application.

FIG. 6 illustrates an embodiment of a process 600, similar to the process 500 of FIG. 5, however, the printing surface 602 comprises a plate. The fiber bed 604 rotates relative to the printing surface 602 to apply the discrete resin regions 606 to the surface 608 of the fiber bed 604. Similar to the process of FIG. 5, a measuring blade, a doctor blade, or the like 610 may be utilized to remove excess resin 612 from the printing surface 602 of the plate before the surface 602 is placed into contact with the fiber bed 604. The fiber bed 604 may rotate along with a roller 614 to which it is coupled.

The processes of FIGS. 5 and 6 may be applied to one surface of the fiber bed, or may be applied to both surfaces (opposing top and bottom surfaces) of the fiber bed either simultaneously or in sequence.

The processes of FIGS. 5 and 6 may be considered to be a form of gravure printing. However, here, discrete resin regions are applied to the surface or surfaces of the fiber bed. Portions of the surface of the fiber bed that are exposed between the discrete resin regions facilitate permeation of air or gas through the surface of the fiber bed in the through-thickness direction of the fiber bed. The methods may be applied to either a fiber bed that comprises a unidirectional fiber bed or a fabric, or a non-crimp fabric, or a textile. The method does not rely on the surface topography or architecture of the fiber bed to produce the desired resin regions on the surfaces.

In one embodiment, the methods of FIGS. 5 and 6 may be modified such that a grid of perforations can be introduced to a continuous resin film by passing it over a perforating roller, producing a grid-like pattern of resin with periodic gaps.

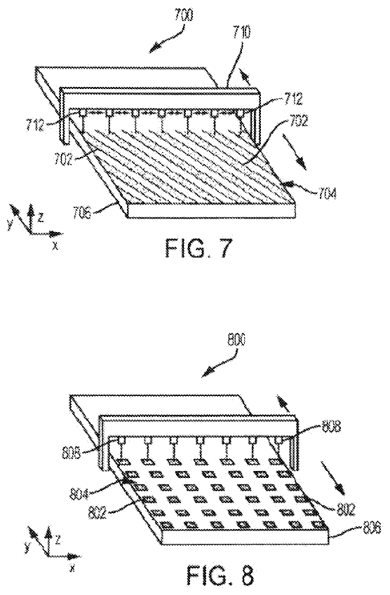

FIG. 7 illustrates a process 700 of droplet deposition used to form a number of discrete resin regions 702 on a surface 704 of a fiber bed 706. The deposition process results in the number of discrete resin regions 702 and portions of the surface 704 between the resin regions 702 (shown in FIG. 7).

The droplet deposition process may involve spraying droplets of the resin material upon the surface 704 of the fiber bed 706. A desired configuration of discrete resin regions 702 may result on the surface 704. In FIG. 7, the discrete resin regions 702 are shown to form parallel strips extending diagonally along the surface 704 of the fiber bed 706. In other embodiments, other configurations of the discrete resin regions may be applied, including extending longitudinally along the length of the fiber bed 706 (the “y” axis direction shown in FIG. 7) or width of the fiber bed 706 (the “x” axis direction shown FIG. 7), or grids, or other patterns (regular or irregular), or any other configurations.

The droplet deposition may occur through a droplet deposition apparatus 710, which may include one or more nozzles 712 coupled to a frame 710. The nozzles 712 may be configured to move relative to the fiber bed 706 to apply a desired configuration of discrete resin regions 702 to the surface 704. The nozzles 712 or fiber bed 706 may be configured to move relative to each other to allow for movement in the x-axis direction or the y-axis direction (or the z-axis direction). The nozzles 712 may deposit the droplets in this manner upon the surface 704.

FIG. 8 illustrates a process 800, similar to the process 700 of FIG. 7, however droplet deposition here is used to apply a grid of discrete resin regions 802 to the surface 804 of the fiber bed 806. The one or more nozzles 808 may be configured to spray the resin material in such a manner that desired spacing occurs between adjacent discrete resin regions 802 in the x-axis direction and the y-axis direction (as shown in FIG. 8).

The processes of FIGS. 7 and 8 result in application of the resin in a manner similar to ink jet printers. Patterns of resin with specific widths and spacing may result.

The processes of FIGS. 7 and 8 may be applied to one surface of the fiber bed, or may be applied to both surfaces (opposing top and bottom surfaces) of the fiber bed either simultaneously or in sequence. Portions of the surface of the fiber bed between the discrete resin regions facilitate permeation of air or gas through the surface of the fiber bed in the through-thickness direction (corresponding to the “z-axis” direction shown in FIGS. 7 and 8) of the fiber bed. The methods may be applied to either a fiber bed that comprises a unidirectional fiber bed or a fabric, or a non-crimp fabric, or a textile. The method does not rely on the surface topography or architecture of the fiber bed to produce the desired resin regions on the surfaces.

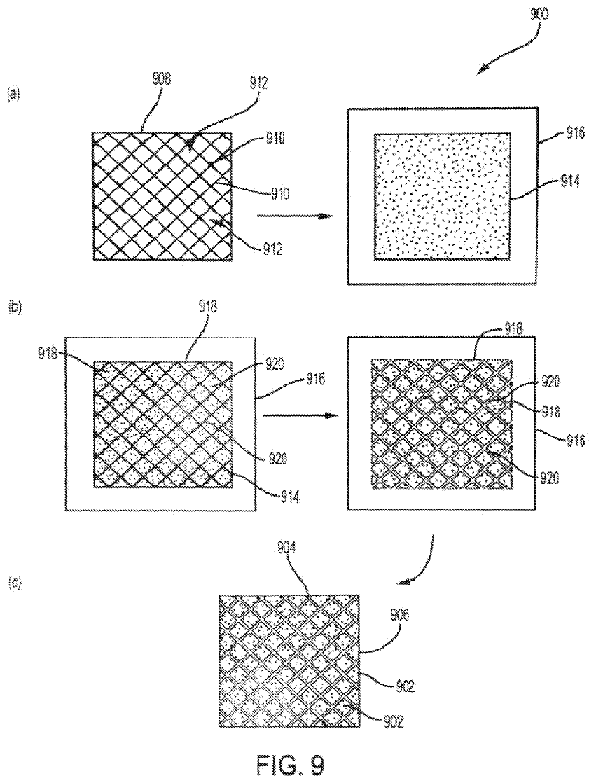

FIG. 9 illustrates a process 900 utilizing de-wetting to assist in the formation of discrete resin regions 902 to a surface 904 of a fiber bed 906. The steps outlined in FIG. 9 may be varied, excluded, reordered, or supplemented as desired. In step (a) of FIG. 9, an imprint tool 908 may be provided. The imprint tool 908 may comprise a cutter device, a perforation device, a stencil, or other forms of imprint tools 908. Roll cutters may be utilized. In FIG. 9, the imprint tool 908 is shown as a cutter device in the form of a honeycomb sheet with rigid structures 910 separated by voids 912. The imprint tool 908 may comprise a metallic honeycomb sheet. The imprint tool 908 may be configured to have a shape corresponding to the desired shape of the discrete resin regions.

In step (a) of FIG. 9, the imprint tool 908 may be applied to a continuous resin film 914. The resin film 914 may be positioned on a backing substrate 916 such as a backing paper or other forms of substrates, such as a carrier sheet. In an example, the carrier sheet may have a low friction or low surface energy surface so as to facilitate the release and transfer of the discrete resin regions formed thereon onto the fiber resin bed. The application of the imprint tool 908 to the resin film 914 may make imprints on the continuous resin film 914.

Step (b) of FIG. 9 illustrates the result of the imprint tool 908 upon the resin film 914. The imprint upon the resin film 914 operates to physically cause nucleation of the resin film to form a number or a plurality of discrete resin regions 918 of the resin film 914. The imprint may define a desired configuration (such as a regular or irregular pattern, or other configurations as disclosed herein or desired). The imprint may comprise perforations in the film. The imprint may result in a number of imprint sites 920 between the resin regions 918. The desired configuration of discrete resin regions 918 may be controlled by controlling the imposed imprint site in a desired configuration. For example, in an embodiment in which a cutter tool is used as the imprint tool 908, the cutting pattern may define the configuration of the discrete resin regions 918. Various configurations of imprint sites 920 may be produced to result in the desired configuration of resulting discrete resin regions.

The arrow between the two images of step (b) of FIG. 9 represents a de-wetting process for the imprinted resin film 914. The de-wetting process varies the dimensions of the resin regions 918 to increase a distance of the discrete resin regions 918 from or between each other. The resin regions 918 recede from the imprint sites 920. This may leave openings between the discrete resin regions 918 and may expose the underlying surface of the backing substrate or carrier 916. The de-wetting processes may include application of heat to the resin film 914 and/or the backing substrate or carrier. For example, in one embodiment, the resin film 914 may be heated with an oven (e.g., the resin film and backing plate or carrier may be placed in an oven) or may be heated with another form of heating device, such as by radiant heat provided by radiant heating elements such as light bulbs or the like. The oven may comprise a conveyor oven. The resin film may pass through the conveyor oven. The heating may comprise a brief process. The film 914 when heated de-wets by nucleating and receding from the imprints, forming an intended configuration or pattern of openings therebetween. In other embodiments, other forms of de-wetting may be utilized or otherwise trigger de-wetting, and may produce a similar result.

In step (c) of FIG. 9, the discrete resin regions 918 may be applied to the surface 904 of the fiber bed 906 to form the discrete resin region 902 thereon. The discrete resin regions 918 may be transferred to the fiber bed 906 to apply the regions 918 thereon. The discrete resin regions 902 may have a desired configuration. As shown in step (c) of FIG. 9, the discrete resin regions 902 may form a grid, or may form other configurations as disclosed herein (e.g., parallel strips, other forms of grids, or patterns, among others). In an example, the discrete resin regions formed by the de-wetting process and disposed on the backing substrate or carrier may be transferred to the surface of the fiber bed by combining the surface of the backing substrate or carrier comprising the discrete resin regions with the surface of the fiber bed, e.g., under conditions of pressure and or heat. In an example the discrete resin regions may be transferred to the surface of the fiber bed by the use of rollers or the like, wherein the backing substrate and fiber bed are run between a set of rollers to imposed a desired pressure to effect the transfer of the discrete resin regions onto the fiber bed surface. This is but one method of how the transfer may be performed, and it is to be understood that other transfer methods may be used.

In one embodiment, the resin film 914 (previously imprinted or not) may be positioned on the fiber bed 906 prior to the de-wetting process. In such embodiment, the resin film 914 may be imprinted on the fiber bed 906 and may be de-wetted after the resin film 914 is applied or transferred to the surface of the fiber bed 906. In one embodiment, the resin film 914 may be imprinted prior to being applied to the fiber bed 906 and may be de-wetted after being applied to the fiber bed 906. In embodiments, resin material may be de-wetted prior to, during, or after the resin material is deposited onto the surface of the fiber bed.

The processes of FIG. 9 may be applied to one surface of the fiber bed, or may be applied to both surfaces (opposing top and bottom surfaces) of the fiber bed either simultaneously or in sequence. Portions of the surface of the fiber bed between the discrete resin regions may facilitate permeation of air through the surface of the fiber bed in the through-thickness direction of the fiber bed. The methods may be applied to either a fiber bed that comprises a unidirectional fiber bed or a fabric, or a non-crimp fabric, or a textile. The method does not rely on the surface topography or architecture of the fiber bed to produce the desired resin regions on the surfaces. This method may be particularly useful as a retrofit for existing prepregging machines.

In one embodiment, the processes of FIG. 9 may be modified such that resin film is heated to create perforations on UD (unidirectional) fibers.

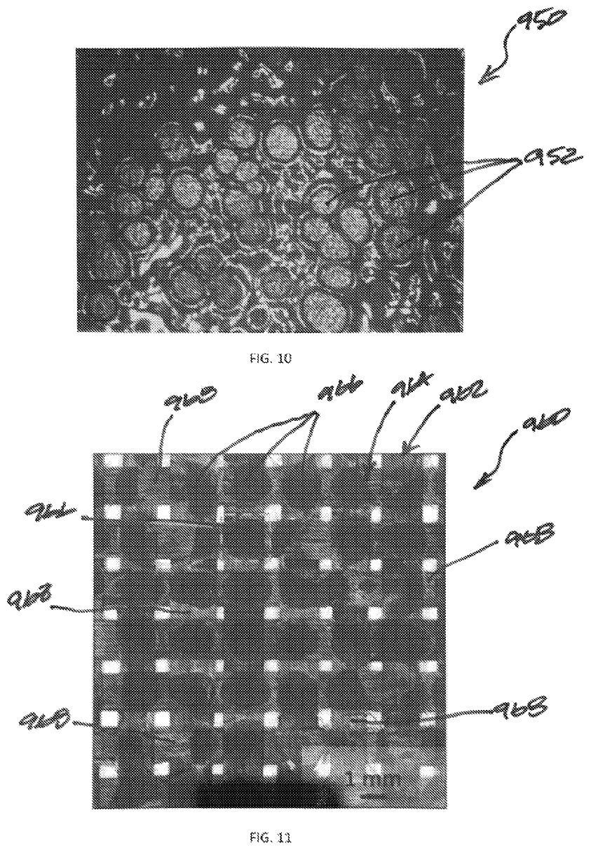

While one approach of forming the discrete resin regions by de-wetting has been disclosed above and illustrated in FIG. 9, it is to be understood that other de-wetting approaches or techniques may be used. For example, rather than using an imprint tool to physically form an imprint on the resin film (nucleated de-wetting), the resin film may relay on the de-wetting condition of elevated temperature to cause formation of the discrete resin regions. In this example, the discrete resin regions result from a combination of the reduced viscosity of the resin film and the low surface energy of the backing substrate or carrier under elevated temperature conditions to form the discrete resin regions (un-nucleated de-wetting). FIG. 10 is photomicrograph of a resin film that has been subjected to such an un-nucleated de-wetting process using only elevated temperature to form a plurality of discrete resin regions that are separated from one another by regions that either have no resin or that have a minor residual amount of resin that is inconsequential for the purposes of forming the desired prepreg by transfer of the discrete resin regions to the surface of the fiber bed as described above, e.g., by using pressure and heat.

FIG. 11 is a photomicrograph of a prepreg 960 as disclosed herein comprising a fiber bed 962 having a surface 964 comprising a plurality of discrete resin regions 966 formed by the un-nucleated de-wetting process described above and disposed thereon providing a plurality of exposed fiber bed surface regions 968 to facilitate through-thickness passage of air or gas from the prepreg 960 during prepreg processing, e.g., during a cure process.

The methods of de-wetting as disclosed above make use of backing substrates or carriers that have no surface features useful for causing formation of the discrete resin regions. However, it is to be understood that backing substrates comprising certain surface features such as ridges or the like may be used to provide nucleated de-wetting that functions to physically cause formation of the discrete resin regions during the de-wetting process.

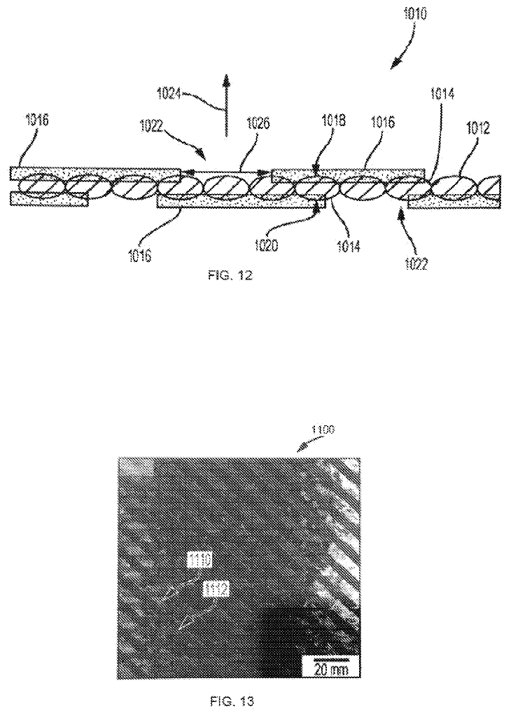

FIG. 12 illustrates a cross-sectional illustration of a prepreg 1010 in which a fiber bed 1012 is in the form of a unidirectional fiber bed. The unidirectional fibers 1014 are shown extending outward from the page. Discrete resin regions 1016 are disposed on top and bottom surfaces 1018, 1020, respectively, of the fiber bed 1012. The discrete resin regions 1016 are separated by portions (e.g., portion 1022) of the fiber bed surface that are exposed and not covered by or impregnated with resin. The exposed portions 1022 facilitate permeation of air through the surface of the prepreg in the through-thickness direction 1024 during prepreg processing, e.g., during a curing process.

A distance 1026 between the resin regions 1016 may be set such that limited resin flow is required to close the gap between resin regions 1016 during curing. In embodiments according to the methods disclosed herein, the distance 1026 may have a range of between 0.1 millimeters (mm) and 10 mm. In other embodiments, other ranges of distances 1026 may be utilized. In embodiments, the distances may be determined based on resin chemistry, desired temperature cure cycles, and/or end-use application, among other factors.

The prepreg 1010 disclosed in FIG. 12 may be produced by the processes disclosed herein. The discrete resin regions 1016 may be produced by the processes disclosed herein.

The processes disclosed herein may not only be used to produce prepregs with unidirectional fiber beds, as disclosed in FIG. 12, but may also be used to produce prepregs with fabric or non-crimp fabric or a textile. The cross section of FIG. 12 will appear similar, with the configuration of the fibers therein varied according to the type of fabric, non-crimp fabric, or textile. The processes disclosed herein are not dependent on a particular surface topography or architecture of the fabric bed, and may accordingly be used with either fabric or a non-crimp fabric or a unidirectional fiber bed or a textile.

The use and presence of discrete resin regions 1016 with a unidirectional fiber bed, and the processes of making such a prepregs with a unidirectional fiber bed, as disclosed herein, are novel, as well as the other methods, apparatuses, and systems disclosed herein.

A benefit of the air channels formed in the through-thickness direction of the prepregs disclosed herein is reduced void formation (both internal voids or internal porosity and surface voids). The through-thickness air channels allow for improved withdrawal of air or other gas during prepreg processing such as during a curing process, which may include vacuum processes and a heating process. A much greater through-thickness permeability is produced to enhance air removal to thereby promote processing efficiency, and reduce defects in parts. Prepregs produced as disclosed herein may result in composite structures, products, or parts formed during a curing process having near-zero internal void formation (near-zero porosity) and flawless external surfaces.

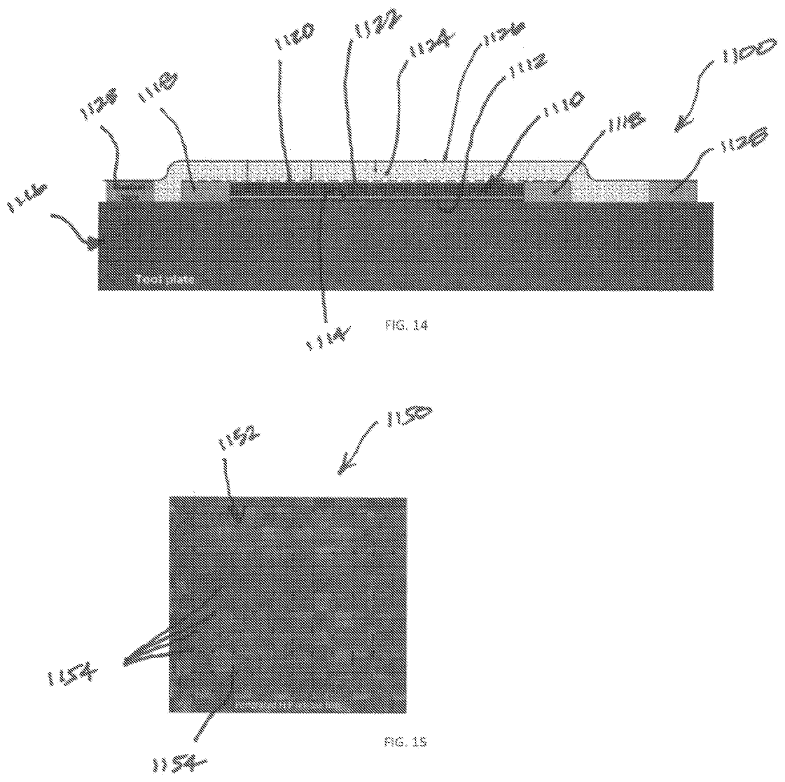

FIG. 13 illustrates an example prepreg 1100 made in accordance with the principles disclosed herein comprising a number of discontinuous resin regions 1110 (in the form of parallel strips) disposed on a surface of a unidirectional fiber bed, and a number of exposed surface regions 1112 of the unidirectional fiber bed that are exposed and not covered by the resin regions or strips to thereby create much greater through-thickness permeability to enhance air or gas removal and reduce defects in parts as noted above.

The composite part formation and curing processes disclosed herein may include a process of layering multiple prepregs (prepreg plies), such as the prepreg 1010 shown in FIG. 12. Multiple layers or plies of the prepreg may be stacked together. A composite part resulting from the methods disclosed herein may comprise the cured prepreg (single layer or ply), or may comprise a cured stack of the prepreg, or may comprise the ultimate resulting composite structure, product, or part (e.g., aerospace part such as a fuselage, or sporting good part such as a sailing mast, among others). The composite parts comprise a part of the disclosure herein. The presence of the through-thickness air channels allows for multiple plies to be utilized without significant increase in internal void content (thereby maintaining the desired lack of internal voids) or significant decrease in internal microstructure quality. The multiple plies may be cured together in a lamination process. The curing processes may include a vacuum process, or a heating process, or other curing process, and combinations thereof. The curing processes preferably occurs OoA, and preferably in a vacuum bag only (VBO) implementation. The methods herein may include placing the prepreg or layers of prepreg in a vacuum bag for a curing process, which may include vacuuming air from the prepreg(s) and heating, among other processes. It is contemplated other forms of curing processes may be utilized. The curing processes of any of the methods disclosed herein may occur in an autoclave or through another curing mechanism.

Prepregs made according to the methods disclosed herein may comprise materials conventionally used to form prepregs, which may include and not be limited to carbon or glass fiber, and epoxy, polyimide, BMI, cyanate ester, polyurethane, phenolic, or other polymer resin and the like.

A benefit common to all of the prepreg embodiments disclosed herein is that the selection of widths and spacing of the discrete resin regions affords control of the resin distribution both in the prepreg and in the resulting composite product, structure, or part formed therefrom. An advantage of such prepregs as disclosed herein over most commercial prepregs is the greater through-thickness air or gas permeability, which enables and facilitates air and gas removal from the prepreg during processing and cure when in-plane channels are inadequate. A further feature and advantage of the methods disclosed herein may be that the resin is applied to fiber beds by a continuous process that affords control of the spatial distribution of the resin. The methods disclosed herein may remove the present part size limitation inherent with current OoA processing methods, and make the process of producing composite parts with OoA prepregs more robust by promoting through-thickness (in addition to in-plane) air removal. The methods disclosed herein also may occur independent of a surface topography or architecture of the underlying fiber bed, which enhances the breadth of utility of the processes and may reduce processing expenses.

Additionally, prepregs as disclosed herein allow for flexibility in processing in that such prepregs may be made and then subsequently subjected to processing for forming desired composite products, structures, or part in a continuous process. Alternatively, prepregs as disclosed herein may be made and then stored for processing at a later date. In an example, prepregs as disclosed herein may be rolled, stacked, folded, or the like and stored for a period of time until later subjected to processing. This ability to store the prepregs enable the prepregs to be made at one location and then processed at another location adding geographic flexibility to the process of making and the subsequently processing the prepregs. A further feature of the prepregs disclosed herein is that they contain all of the resin (in the form of the discrete resin regions) for processing and forming a resulting composite structure, product, or part such that no further resin is added to the prepreg (i.e., by injection or other process) before or during processing.

Thus, the methods as disclosed herein for making prepregs may enable production of high-quality composite products, structures, or parts, including large parts and parts having complex geometries, and do so in a manner avoiding the need to use autoclaves. The prepreg constructions and products resulting from such methods as disclosed herein may have formats (resin and fiber distributions) that are optimized for production of challenging parts.

Prepregs as disclosed herein are processed to form a desired composite structure, product, or part by combining the prepreg with a suitable forming tool and, in an OoA process, sealing the prepreg within a bag that is configured to receive vacuum and in an example placing the assembly in an oven for subjecting the assembly to a desired elevated processing temperature. Alternatively, such process may also be achieved using a heated forming tool or by placing a heating member such as a heating blanket or the like over the assembly, wherein such heating blanket may comprise heating elements such as resistive heating elements and such heating elements may be controlled by a control system to provide desired temperature cycles. Accordingly, it is to be understood that methods for processing prepregs as disclosed herein is not limited to oven-based curing approaches. In an example embodiment, the processing vacuum pressure may be from about 0 to 1 PSI, the elevated temperature may be from about 100 to 200° C., and the processing time may be from about 20 to 500 minutes. It is to be understood that such prepreg processing conditions can and will vary from that provided above depending on such factors as the type of resin being used, and thickness or number of plies used to make up the prepreg, the total size of the prepreg, and the like.

FIG. 14 illustrates a conventional prepreg processing assembly 1100 used for an OoA process comprising vacuum-bag processing of through-thickness permeable prepregs as disclosed herein used for OoA processing, e.g., in an oven as described above. The prepreg 1110, comprising the discrete resin regions embodied as described above, is disposed with one of its surfaces 1112 placed against an adjacent surface 1114 of a forming tool or element 1116, e.g., a tool plate. Sealing elements 1118 are positioned at opposed ends of the prepreg 1110 to prevent in-plane air or gas or resin passage from the prepreg (as the prepreg is intentionally engineered to provide through-thickness air or gas permeability). In such conventional prepreg processing assembly, a perforated release film 1120 is placed over a surface 1122 of the through-thickness permeable prepreg 1110 opposite the forming tool 1116, wherein the perforated release film 1120 is configured having a plurality of holes or openings extending therethrough and distributed throughout to permit the escape of air or gas from the prepreg during processing. In an example, a suitable perforated release film 1120 that may be used is one made by Airtech International Inc., such as A4000, which is perforated fluoropolymer high temperature and high elongation release film that conforms easily to accommodate complex curvatures and that releases after being used in processing the composite product, structure, or part. In an example, a breather material 1124, e.g., formed from a breathable cloth material or to the like, is positioned on top of the perforated release film and extends completely over the prepreg 1110 and the sealing elements 1118. A vacuum bag 1126 is placed over the breather material 1124 and is sealed at opposed ends by sealing elements 1128, e.g., a sealing tape or the like, to provide an air-tight environment within the vacuum bag 1126. The vacuum bag 1126 is connected to a vacuum source (not shown) for purposes of subjecting the contents within the vacuum bag to a desired vacuum pressure during prepreg processing.

During processing, the prepreg processing assembly 1100 is subjected to the vacuum and temperature conditions as noted above. During an initial step or debulking stage of processing the assembly is subjected to the vacuum condition without heating for purposes of removing air from the prepreg through the exposed surface of the prepreg fiber bed. Ideally, it is desired to remove substantially all of the air from the prepreg during this initial step. In a second step, while the vacuum condition is maintained, the assembly is heated or subjected to an elevated temperature causing the discrete resin regions in the prepreg to flow together and fill or impregnate the manufactured dry regions in and throughout the prepreg fiber bed. The vacuum and temperature condition is maintained for a period of time to ensure that the fiber bed is completely saturated and to cure the resin when the fiber bed is in such completely saturated state.

Using such conventional processing assembly 1100 and method described above and illustrated in FIG. 14 it was discovered that the resulting composite structure, product, or part formed therefrom displayed some degree of internal porosity or voids, this despite the use of the prepregs disclosed above engineered to provide an enhanced degree of air and gas extraction in the through-thickness direction. In an example, the composite structure, product, or part formed in accordance with using the conventional prepreg processing assembly 1100 of FIG. 14 by the vacuum and temperature processing conditions disclosed above displayed greater than about 1.5 percent by volume internal voids, and greater than about 1.5 percent by area surface voids.

For purposes of better understanding the cause of such unwanted internal and surface porosity or voids, the pressure behavior inside of the prepreg during processing was monitored. In an example, a pressure measurement device comprising a pressure sensor or transducer (e.g., a Honeywell Model S transducer) attached with an element comprising a reservoir filled with a high-temperature oil transfer medium (e.g., synthetic oil rated for use up to 200° C.) was developed. A needle tube or probe (19-gauge stainless steel with a 90 degree tip) extended from the element and was sized having a sufficient length to extend from a position outside of the prepreg processing assembly (removed from processing vacuum and temperature condition) into the prepreg processing assembly. The needle tube or probe had an open end that was disposed into the prepreg between piles (exposed to the processing vacuum and temperature condition and in contact with the resin within the prepreg during processing), wherein the needle tube was sealed with a small amount of excess resin to prevent a pressure loss during the initial vacuum application but once it was exposed to elevated temperatures the excess resin became liquid (prior to curing) and enabled direct measurement of liquid resin pressure. In an example, the probe was oriented parallel to the tool plate and the prepreg or laminate, was inserted between second and third piles of the prepreg or laminate.

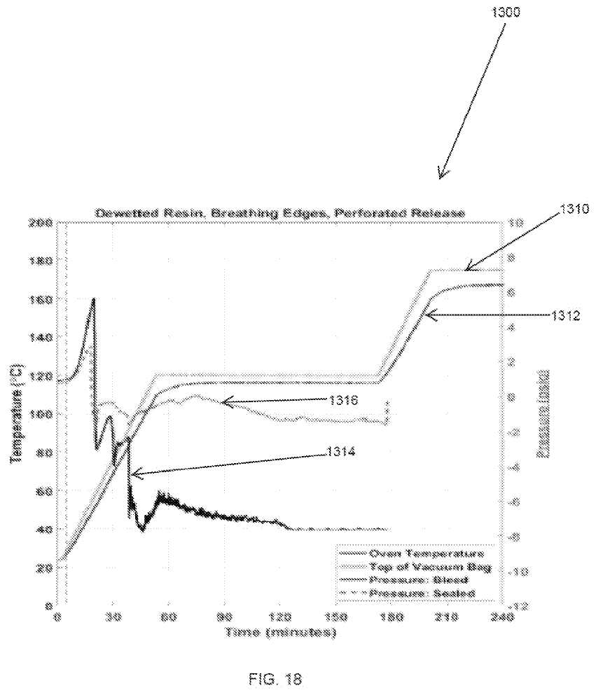

Using such pressure measurement device it was discovered that during the second step of processing a pressure drop in the resin occurred that was determined to be associated with the migration or flow of resin within the prepreg to fill the manufactured dry spots of the fiber bed. After this initial pressure drop in the resin, during further processing it was discovered that the resin pressure within the prepreg continued to drop, so that the pressure being imposed on the prepreg by the vacuum conditions and the associated pressure force inside the prepreg was shifting from the resin to the fiber bed, i.e., the resin was no longer carrying the pressure load. The resin pressure characteristics described above are illustrated in FIG. 18 presented and described below. The loss in resin pressure within the prepreg was determined to promote the formation of the internal voids or pores due to bubble formation and growth in the resin. The cause for the discovered drop in resin pressure within the prepreg during processing was investigated and discovered to be caused by unwanted resin bleeding out of the prepreg. The cause of the resin bleed was investigated and determined come from the surface of the prepreg covered with the perforated release film, as the perforated release film not only permitted the desired passage of air or gas from the prepreg but also permitted the unwanted excess passage of resin from the prepreg surface during processing (i.e., the perforated release film was discovered to be resin permeable).

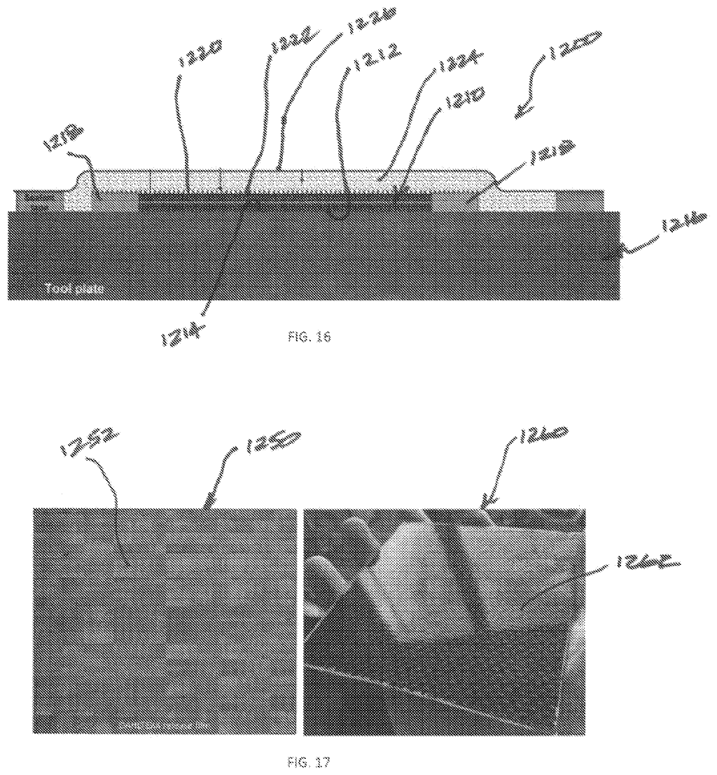

FIG. 15 is a photomicrograph of a composite part 1150 formed according the process described above using the perforated release film causing the unwanted resin bleed. The composite part surface 1152 shows a number of voids 1154 distributed along the surface 1152 as a result of such unwanted resin bleed during prepreg processing as described above.

To address this issue, a solution for minimizing and/or eliminating such unwanted resin bleed from the prepreg surface during processing was investigated. As the perforated release film was discovered to be the cause for the resin bleed, it was eliminated. In its place an air permeable resin barrier material was tested, as such material was specially engineered to preserve air permeability while preventing resin passage. In an example, the air permeable resin barrier material may be referred to as a semipermeable membrane that permits air flow and prohibits or prevents resin flow. In an example, an air permeable resin barrier suitable for use during prepreg processing may be used is one made by Airtech International Inc., such as Dahltexx SP-2 made from nylon and that is in the form of a membrane having a micro-porous structure specially configured to allow air or gas passage and restrict the flow of resin, wherein information concerning this material is hereby incorporate herein by reference. While an example air permeable resin barrier material has been disclosed, it is to be understood that other materials or products may be used that provide the same or similar function (to permit air passage and restrict or prevent resin passage), and that all such other products are intended to be within the scope of this description.

FIG. 16 illustrates a prepreg processing assembly 1200 as disclosed herein configured for prepreg processing. The prepreg may be processed by an OoA process comprising vacuum-bag processing of a prepreg under elevated temperature conditions, e.g., provided by an oven or other heating member, as described above. Similar to the prepreg processing assembly illustrated in FIG. 14, the assembly 1200 comprises a prepreg 1210, comprising the discrete resin regions embodied as described above, that is disposed with one of its surfaces 1212 placed against an adjacent surface 1214 of a suitable forming tool or element 1216, e.g., a tool plate. Sealing elements 1218 are positioned at opposed ends of the prepreg 1210 to prevent in-plane resin passage from the prepreg during processing (as the prepreg is intentionally engineered to provide through-thickness air or gas permeability). In such prepreg assembly 1200, an air permeable resin barrier material or semipermeable membrane 1220 as disclosed above was placed over a surface 1222 of the prepreg 1210 opposite the forming tool 1216, e.g., surrounding the surface 1222, wherein the air permeable resin barrier material 1220 facilitates the escape of air or gas from the surface of the prepreg while restricting or preventing the passage of resin from the prepreg surface 1222 during processing. The prepreg 1200 as combined with the air permeable resin barrier material 1220 may be referred to as a prepreg assembly. In an example, a breather material 1224 as disclosed above is positioned on top of the air permeable resin barrier material 1220 and extends completely over the prepreg 1210 and the sealing elements 1218. A vacuum bag 1226 is placed over the breather material 1224 and is sealed at opposed ends by sealing elements 1228, e.g., a sealing tape or the like, to provide an air-tight environment within the vacuum bag 1226. The vacuum bag 1226 is connected to a vacuum source (not shown) for purposes of subjecting the contents within the vacuum bag to a desired vacuum pressure during prepreg processing.

The above-described prepreg processing assembly 1200 was subjected to processing under vacuum and temperature conditions as disclosed above for the conventional prepreg process assembly 1100 of FIG. 14. The pressure within the prepreg 1210 was monitored using the pressure monitoring device described above to evaluate and monitor the resin pressure in the prepreg during prepreg processing. It was observed that after an initial pressure decrease, during the second step or stage of processing due to the initial migration or flow of resin within the prepreg to fill the dry spots of the fiber bed, that (unlike the conventional prepreg assembly 1100 using the perforated release film 1120 of FIG. 14) the resin pressure within the prepreg 1210 of the prepreg processing assembly 1200 did not drop in the manner observed and discussed above with reference to the conventional prepreg processing assembly 1100 of FIG. 14. Rather, the resin pressure within the prepreg 1210 remained relatively stable throughout the remainder of the prepreg processing. In an example, once the fiber bed was saturated with resin, the resin within the prepreg maintained at least 50 percent of its pressure through the remainder of processing. In an example, the resin within the prepreg may maintain from about 50 to 100 percent, and from about 60 to 90 percent of its pressure through the remainder of processing. In a specific example, the resin within the prepreg maintained approximately 86 percent of its pressure through the remainder of processing.

After processing, the prepreg processing assembly 1200 was disassembled and inspected for any indication or signs of resin bleed and there was no sign resin bleed that was observed from the surface of the prepreg 1200 indicating that the air permeable resin barrier material functioned to prevent unwanted migration of resin from the surface of the prepreg during processing. The composite structure, product, or part formed from the prepreg processing using the air permeable resin barrier material was both surface inspected and cross-sectioned for evidence of internal voids or pores, and very few if any internal or surface voids or pores were observed. In an example, the composite structure, product, or part formed in accordance with using the prepreg processing assembly 1200 of FIG. 16 by the vacuum and temperature processing conditions disclosed above displayed near-zero voids of less than about 0.5 percent by volume voids and less than about 0.5 percent by area surface voids.

FIG. 17 are photomicrograph of two composite parts 1250 and 1260 that were each formed according the prepreg processing process described above using the prepreg processing assembly 1200 of FIG. 16 comprising the air permeable resin barrier material 1220. Surfaces 1252 and 1262 of respective composite parts 1250 and 1260 displayed substantially no voids or pores, which is attributable to the combined function of the prepreg having through-thickness air or gas permeation to facilitate heighted air or gas removal during processing, along with the air permeable resin barrier material that restricts or prevents resin bleed to maintain resin pressure thereby mitigating bubble formation and resulting internal void formation during processing.

FIG. 18 is a graph 1300 that illustrates certain temperature and pressure measurements taken during an example vacuum and temperature processing of prepregs as disclosed above. Specifically, illustrated is the oven temperature 1310 and the vacuum bag temperature 1312 as a function of time during prepreg processing of the prepreg processing assembly of FIG. 14 (using the perforated release film). For purposes of reference, the oven temperature and vacuum bag temperature for the prepreg processing assembly of FIG. 16 (using the air permeable resin barrier material) are similar to that illustrated in FIG. 18.

FIG. 18 also illustrates a detected pressure 1314 of the resin in the example prepreg 1120 of the example prepreg processing assembly 1110 of FIG. 14 as a function of time during processing. The detected resin pressure 1314 can be seen to decrease from approximately 0 Psig after minute 30 during the process which is a time during the process when the resin should have been in a liquid state and the fiber bed may be at least partially if not fully saturated with the resin. FIG. 18 also illustrates a detected pressure 1316 of the resin in the example prepreg 1210 of FIG. 16 for purposes of contrasting with the detected resin pressure 1314. As illustrated, the detected resin pressure 1316 maintains higher pressure during the course of processing, due to use of the air permeable resin barrier material that restricts or prevents excessive resin bleed, thereby helping to mitigate the unwanted formation of internal voids in the resulting composite structure, product, or part.

In example conventional prepreg processing assemblies (such as that illustrated in FIG. 14), the resin pressure in the prepreg when subjected to the vacuum and temperature processing conditions disclosed above may drop more than 40 percent, and in some cases more than 50 percent or more than 60 percent from its pressure at a state of processing when the resin is in an a liquid state and the fiber bed is partially or fully saturated. While in example prepreg processing assemblies, as disclosed herein and illustrated in FIG. 16, when subjected to the same vacuum and temperature processing conditions, the resin pressure in the prepreg may drop less than 50 percent, less than 40 percent, less than 30 percent, less than 20 percent, and in some cases less than 10 percent from its pressure at a state of processing when the resin is in an a liquid state and the fiber bed is partially or fully saturated. While certain resin pressures have been provided above, it is to be understood that the exact amount that the resin pressure may drop in prepregs 1120 of the conventional prepreg processing assemblies 1100 of FIG. 14 and prepregs 1210 of the prepreg processing assemblies 1200 of FIG. 16 may vary depending on such factors as the fiber bed used, the resin that is used, the number of plies in the prepreg, the processing vacuum conditions, the processing heating conditions and the like. However, what is clear is that the prepreg processing assemblies 1200 as disclosed herein demonstrated a significantly improved ability to retain resin pressure when contrasted with the conventional prepreg processing assemblies 1100.

A feature of prepreg constructions and assemblies as disclosed herein comprises use of the composite prepreg of the type disclosed above having high air or gas permeability in the through-thickness direction as combined with an air permeable resin barrier material or semipermeable membrane in place of a perforated release film, and in an example with side edges of the prepreg laminate sealed. Such prepreg constructions facilitate air evacuation over the entire prepreg surface, while retaining all resin in the prepreg plies during processing (thereby preserving the original resin content and preserving the original fiber:resin ratio or proportions of the prepreg). The efficiency of air removal during processing reliably prevents voids due to entrapped air, while the prevention of resin bleed during processing from use of the air permeable resin barrier material ensures that resin pressure is maintained (and thus avoids void formation due to resin volatility). As noted above, prepreg constructions as disclosed herein make use of through-thickness permeable prepregs that comprise a resin:fiber ratio that is fixed before being combined with the air permeable resin barrier material and other elements to form the prepreg processing assembly for processing, e.g., under vacuum and elevated temperature conditions. Before, or during such processing of the prepreg there is no further resin that is provided, e.g., by injection or other technique, such that the only resin present is that initially provided in the form of the discrete resin regions disposed on the fiber bed.

Exemplary embodiments of the methods/systems/constructions have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted except in light of the appended claims and their equivalents.

The prepreg constructions and assemblies as disclosed herein may be utilized in a variety of industries, including production or repair of composite parts for aerospace (including aircraft parts, aircraft body parts, fuselage parts, among others) and sporting goods (including sailing masts, bicycle frames, and fishing rods), among other industries. Industries may also include composite parts for wind power, and automotive. Other applications may include medical (prosthetics, among others). The resulting composite parts disclosed herein may include aircraft parts, aircraft body parts, fuselage parts, wing parts, other aerospace parts, sailing masts, sail boat body parts, tennis racket handles, golf clubs, other sporting good parts, wind power generation parts, other wind power parts or power generation parts, automotive body parts (e.g., bumpers, frames, etc.), other automotive parts, prosthetics, other medical parts, among other composite parts and industries.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the systems, apparatuses, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, apparatuses, and methods and does not pose a limitation on the scope of the systems, apparatuses, and methods otherwise claimed. No language in the present specification should be construed as indicating any non-claimed element essential to the practice of the systems, apparatuses, and methods.

What is claimed is:

1. An assembly used for making a composite structure comprising:
a prepreg comprising a fiber bed and a plurality of discrete resin regions disposed on a surface of the fiber bed, wherein the discrete resin regions are separated by exposed surface regions of the fiber bed that are not covered by the discrete resin regions; and
an air permeable resin barrier material disposed over the surface of the prepreg comprising the discrete resin regions, wherein the air permeable resin barrier material is permeable to air or gas passing from the prepreg and is impermeable to resin passing from the prepreg;
wherein the prepreg discrete resin regions and exposed fiber bed surface region are configured to facilitate gas removal from the prepreg in a through-thickness direction of the prepreg during a prepreg curing process, and wherein the air permeable resin barrier material is configured to permit such gas removal from the prepreg while preventing resin passage from the prepreg during such prepreg curing process.

2. The assembly as recited in claim 1, further comprising a bag disposed over at least a portion of the prepreg assembly for subjecting the prepreg assembly to a vacuum condition.

3. The assembly as recited in claim 1, wherein the fiber bed is unidirectional.

4. The assembly as recited in claim 1, wherein the discrete resin regions are formed separately from the fiber bed and are disposed thereon in a preformed state.

5. The assembly as recited in claim 4, wherein the discrete resin regions are formed by depositing a film of resin on a carrier and de-wetting the film of resin to form the discrete resin regions, and wherein the discrete resin regions are disposed on the fiber bed surface by pressing a surface of the carrier comprising the discrete resin regions into contact with the fiber bed surface and removing the carrier therefrom.

6. The assembly as recited in claim 1, wherein the discrete resin regions are configured having a uniform pattern on the fiber bed surface.

7. A method for processing a prepreg used to form a composite structure comprising placing an air permeable resin barrier material over a surface of a prepreg, wherein the prepreg comprises a fiber bed having a plurality of discrete resin regions disposed on a surface of the fiber bed and having exposed regions of the fiber bed surface not covered by the discrete resin regions to facilitate through-thickness passage of air or gas from the prepreg during a curing process, and wherein the air permeable resin barrier material is permeable to air or gas passing from the prepreg and is not permeable to resin passing from the prepreg during the curing process.

8. The method as recited in claim 7, where before the step of placing, making the prepreg by depositing the discrete resin regions onto the surface of the fiber bed.

9. The method as recited in claim 7, wherein the discrete resin regions are formed by depositing a resin film onto a surface of a carrier that is separate from the fiber bed and treating the resin film to cause the resin film to disperse into the discrete resin regions.

10. The method as recited in claim 9, wherein the discrete resin regions on the surface of the carrier are deposited onto the surface of the fiber bed by pressing the surface of the carrier comprising the discrete resin regions into contact with surface of the fiber bed surface so that the discrete resin regions adhere to surface of the fiber bed and are transferred from the surface of the carrier.

11. The method as recited in claim 7, further comprising placing a bag over the prepreg and the air permeable resin barrier material for subjecting the prepreg to a vacuum condition during the curing process.

12. The method as recited in claim 11, further comprising curing the prepreg by subjecting the prepreg and the air permeable resin barrier material to a vacuum condition and an elevated temperature for a period of time to remove air or gas from the prepreg and cause the resin to cure to form the composite structure.

13. The method as recited in claim 12, wherein during the step of curing the prepreg the discrete regions of resin flow and saturate the fiber bed, and wherein the resin maintains at least about 50 percent of its pressure through the step of curing.

14. The method as recited in claim 13 wherein the resin maintained from between 60 to 100 percent of its pressure through the step of curing.

15. The method as recited in claim 12, wherein the composite structure comprises less than about two percent by volume internal porosity.

16. A method for making a composite structure comprising the steps of:
making a prepreg by depositing a plurality of discrete resin regions on a surface of a fiber bed, wherein the surface of the fiber bed comprises exposed regions not covered by the discrete resin regions, wherein the exposed regions are configured to facilitate through-thickness passage of air or gas from the prepreg during a curing process;
placing an air permeable resin barrier material over the surface of the prepreg fiber bed to form a prepreg assembly, wherein the air permeable resin barrier material is permeable to gas passing from the surface of the fiber bed and restricts passage of resin from the surface of the fiber bed during a prepreg curing process; and
subjecting the prepreg assembly to a vacuum condition and elevated temperature to evacuate air or gas in the through-thickness direction from the prepreg and cause the discrete resin regions to flow together, saturate the fiber bed, and cure to form the composite structure.

17. The method as recited in claim 16, wherein during the step of making the prepreg, the discrete resin regions are formed separately from the fiber bed by treating a resin film disposed on a surface of a carrier to cause the resin film to be dispersed into the plurality of discrete resin regions on the surface of the carrier.

18. The method as recited in claim 17, wherein the plurality of discrete resin regions on the surface of the carrier are deposited onto the surface of the fiber bed by pressing the carrier into contact with the surface of the fiber bed to cause the discrete resin regions to be transferred to the surface of the fiber bed.

19. The method as recited in claim 16, wherein during the step of subjecting, the resin is pressurized and the resin pressure when in a liquid state and the fabric bed is substantially saturated with the resin remains substantially constant through curing of the resin.

20. The method as recited in claim 16, wherein the composite structure comprises an internal porosity that is less than about two percent by volume based on the total volume of the composite structure.
